(19) United States
(12) Patent Application Publication
(10) Pub. No.: US 2022/0128836 A1
(43) Pub. Date: Apr. 28, 2022

(54) Selectively Operable Eyewear

(71) Applicant: William B. Finley, III, Liberty Hill, TX (US)

(72) Inventor: William B. Finley, III, Liberty Hill, TX (US)

(21) Appl. No.: 17/452,334

(22) Filed: Oct. 26, 2021

Related U.S. Application Data
(60) Provisional application No. 63/106,259, filed on Oct. 27, 2020.

(51) Int. Cl. G02C 3/02

(52) U.S. Cl. CPC G02C 3/02

(57) ABSTRACT

Apparatus and associated methods relate to an eyewear assembly for attaching to a brim of a headwear. In an illustrative example, the eyewear assembly may include a lens module that include at least one optical lens element and at least two coupling modules rotatably coupled to a distal end and a proximal end of the lens module. The lens module, for example, may be rotated, relative to the coupling modules, about a first axis. For example, each coupling module may include an engagement module configured to releasably engage the brim of the headwear and to independently rotate relative to the lens module. Various embodiments may advantageously be adjustably fitted to attach on various types of headwear with brims of different curvatures and shapes.

### CROSS-REFERENCE TO RELATED APPLICATIONS

This application claims the benefit of U.S. Application Ser. No. 63/106,259 titled “Flip-Up Glasses,” filed by William B. Finley, III, on Oct. 27, 2020.

This application incorporates the entire contents of the foregoing application(s) herein by reference.

### TECHNICAL FIELD

Various embodiments relate generally to eyewear accessories.

### BACKGROUND

Persons may employ eyewear for various purposes including vision enhancement, protection, and aesthetics. Some examples of eyewear include glasses (sometimes also called eyeglasses and/or spectacles in various region), sunglasses, and contact lenses. Sometimes, eyewear may have utility, such as goggles (e.g., configured for impact protection, splash protection), glasses with vision corrective lens, and/or sunglasses (e.g., provided with UV filtering).

A headgear is a head covering worn for various reasons. For example, some hats are used for protecting a user against tough weather conditions, for ceremonial reasons, and/or as a fashion accessory. Various type of headgear may be worn. One kind of popular headgear is a baseball cap.

A baseball cap may be a soft hat with a rounded crown and a stiff bill projecting in front. The front of a baseball cap sometimes displays a design or a logo by printing and/or embroidery. Some baseball caps may be fitted to the wearer's head by having an elastic band, a plastic prong-in-a-hole, hook-and-loop material, a zipper, a tri-glide slide, or some combination thereof, in order to quickly adjust and fit different users' heads. Traditionally, a baseball hat is a part of the baseball uniform worn by players, with the brim pointing forward to shield the eyes from the sun. Since the 1980s, varieties of the baseball cap have become prevalent, both for utilitarian purposes of protecting the eyes from the sun and for fashion accessory purposes.

### SUMMARY

Apparatus and associated methods relate to an eyewear assembly for attaching to a brim of a headwear. In an illustrative example, the eyewear assembly may include a lens module that include at least one optical lens element and at least two coupling modules rotatably coupled to a distal end and a proximal end of the lens module. The coupling modules may, for example, be configured such that the lens module may be rotated, relative to the coupling modules, about a first axis. Each coupling module, for example, may include an engagement module configured to releasably engage the brim of the headwear and to independently rotate relative to the lens module. Various embodiments may advantageously be adjustably fitted to releasably attach on diverse headwear.

Various embodiments may achieve one or more advantages. For example, some embodiments may advantageously enable a user to releasably couple a selectively operated eyewear assembly onto various types of headwear with brims of different curvatures and shapes. Some embodiments may, for example, advantageously provide a selective operable interface for the user to operate the eyewear assembly in at least a deployed mode and a stowed mode. Some embodiments, for example, may be directed to providing various operation modes selectable for the user. For example, some embodiments may be directed to providing one or more additional degrees of freedom of the lens module (e.g., relative to a headgear).

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary attachable eyewear employed in an illustrative use-case scenario, the attachable eyewear being selectively operable between a viewing mode and a stowage mode.

FIG. 2A shows a close-up view of an exemplary attachable eyewear in a viewing mode.

FIG. 2B shows a close-up view of an exemplary attachable eyewear in a stowage mode.

FIG. 3 shows an exploded view of an exemplary attachable eyewear.

Like reference symbols in the various drawings indicate like elements.

### DETAILED DESCRIPTION OF ILLUSTRATIVE EMBODIMENTS

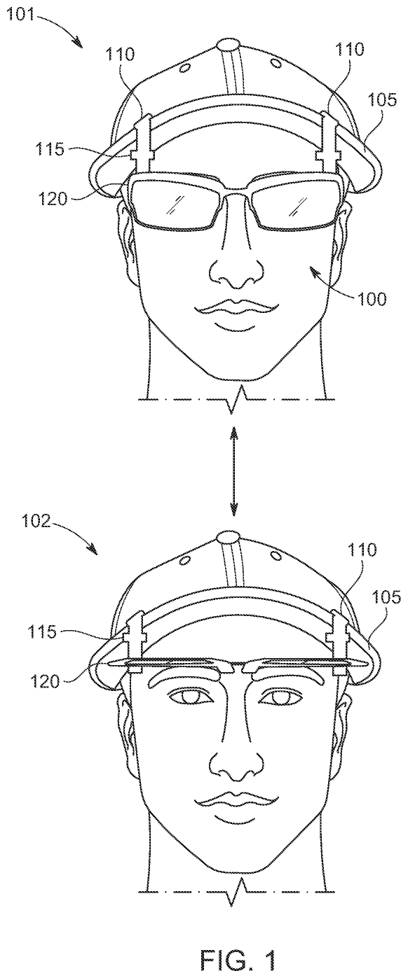

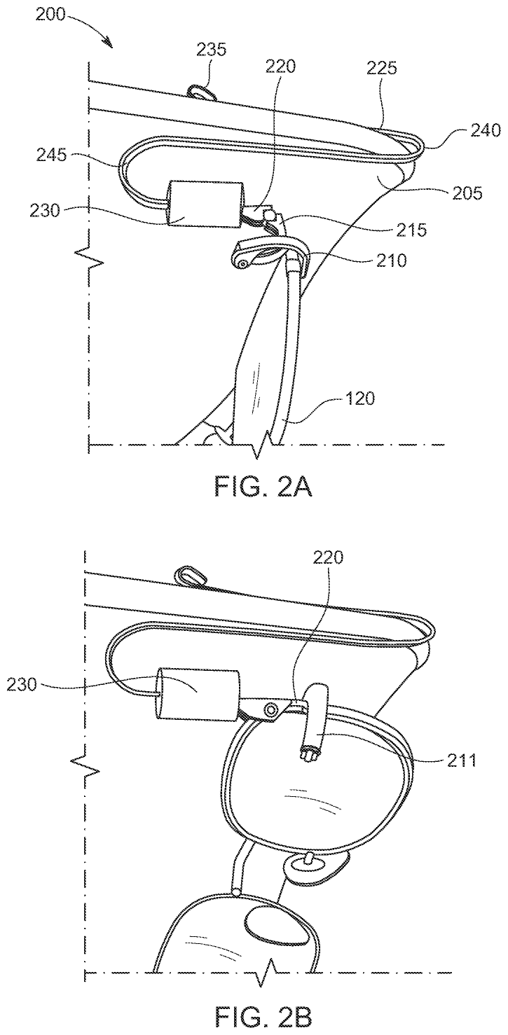

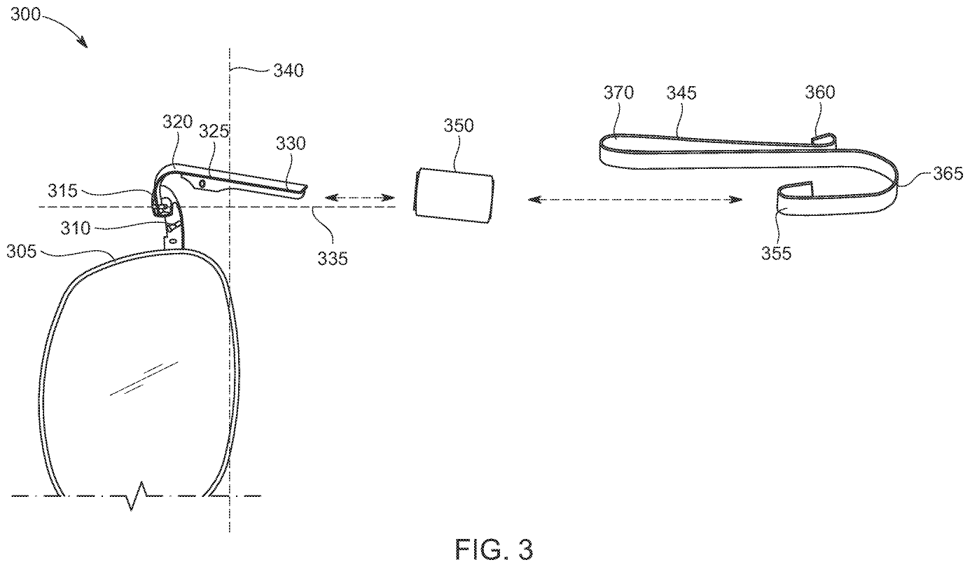

To aid understanding, this document is organized as follows. First, to help introduce discussion of various embodiments, an exemplary attachable eyewear is introduced with reference to FIG. 1. Second, that introduction leads into a description with reference to FIGS. 2A-2B of a detailed exemplary embodiment of the attachable eyewear. Third, the discussion turns to exemplary components of the attachable eyewear with reference to FIG. 3. Finally, the document discusses further embodiments, exemplary applications and aspects relating to flip-up eyeglasses.

FIG. 1 depicts an exemplary attachable eyewear 100 employed in an illustrative use-case scenario, the attachable eyewear being selectively operable between a viewing mode and a stowage mode. In this example, the attachable eyewear 100, in a viewing mode 101 is releasably coupled to a brim 105 of a baseball cap by clips 110. As shown in FIG. 1, the attachable eyewear 100 includes a coupling member 115 at a left at a right end (relative to a perspective of a wearer) of a lens module 120. In this example, the lens module 120 is coupled to the clips 110 via the coupling member 115. A user may, for example, look through the attachable eyewear 100 through the lens embedded in the lens module 120.

In various embodiments, the lens module 120 may be coupled to the coupling member 115 via a pivotable module (not shown). For example, the pivotable module may include a pivot joint connected to the lens module 120 and a pivot member connected to the coupling member 115. For example, the user may operate the attachable eyewear between a viewing mode by pivoting the lens module 120 into a view of sight and a stowing mode by pivoting the lens module 120 away from the view of sight. In some embodiments, the stowage mode may include the lens module 120 oriented such that it lies substantially in a plane that is substantially parallel and offset to a line bisecting the user's eyes while the user is symmetrically wearing, for example, a baseball cap with a brim of the cap disposed such that a symmetrically drawn chord line of the brim lies offset above and substantially parallel to the line bisecting the user's eyes.

As shown in a stowage mode 102, the lens module 120 is rotated, using the pivotable module, substantially about 90 degrees away from a viewing axis of the user. In the stowage mode, for example, the lens module 120 may be positioned substantially parallel to the brim 105 such that they are out of the user's line of sight. Various embodiments may advantageously allow a user to position the attachable eyewear 100 in a desired configuration and easily switch between the viewing mode and the stowage mode without changing the placement of the attachable eyewear 100.

In some implementations, the clips 110 may rotate in the coupling members 115 relative to a position of the pivot joints when the clips 110 are slidably engaging the brim 105. Advantageously, the attachable eyewear 100 may be adjustably fitted to attach on various types of headwear with brims of different curvatures and shapes.

FIG. 2A shows a close-up view of an exemplary attachable eyewear 200 in a viewing mode. In this example, the attachable eyewear 200 is releasably coupled to a brim 205 of a hat (e.g., a baseball cap). The attachable eyewear 200 includes protruding lateral attachment members 210 at opposing ends of the lens module 120. Each lateral attachment member 210 is rotatably joined to a pivot member 215. The pivot member 215 is rotatably joined to a coupling member 220. The coupling member 220 is releasably coupled to a clip 225 by a coupling receiver 230. For example, the coupling receiver 230 may include a sleeve which releasably couples the clip 225 to the pivot member 215. In some implementations, the lens module 120 may be rotatable in relation to the clip 225 based on a flexibility provided by the coupling receiver 230. For example, the coupling receiver 230 may include, in the sleeve, soft coupling materials that the clip 225 may rotate and/or move within the coupling receiver 230. In some implementations, a user may advantageously adjust a coupling position of the clip 225 and the brim 205 independent of a position of the lens module 120.

As shown in FIG. 2A, the clip 225 includes a leading element 235, a spring element 240, and an offset 245. In various embodiments, the leading element 235 may advantageously register with the brim 205 by activating the spring element 240. In some examples, the offset 245 may be advantageously adjusted to position the lens module 120 further or closer to an underside of the brim 205. Accordingly, for example, a user may adjust a position of the eyewear assembly 200 relative to the brim 205 at a desired position relative to a line of sight of the user.

In the depicted embodiment, a user may advantageously rotate the lens module 120 about a rotating joint of the pivot member 215 to switch the eyewear assembly 200 from the viewing mode (e.g., in the user's line of sight) to the stowage mode (e.g., out of user's line of sight). FIG. 2B shows a close-up view of an exemplary attachable eyewear in a stowage mode. As shown, the lens module 120 is rotated substantially parallel to the brim 205, thereby moving out of the user's line of sight. For example, in the stowage mode depicted in FIG. 2B, the lens module 120 may be substantially parallel to a user's line of sight. In various embodiments, a user's line of sight may be an axis and/or range of viewing axes defined when the user is looking straight ahead. In some embodiments the user's line of sight may include a range of viewing axes within a potential field of view of the user. For example, even if a user can look upward and see the lens module 120, the lens module 120 may still be (substantially) out of the user's line of sight for looking past the brim 205. In various implementations, an angle between the lens module 120 in the viewing mode and the stowage mode may be at least 80 degrees.

FIG. 3 shows an exploded view of an exemplary attachable eyewear 300. The attachable eyewear 300 may, for example, be configured as the attachable eyewear 200 such as disclosed at least with reference to FIGS. 2A-2B In this example, the lens module 305 includes a lateral attachment member 310. The lateral attachment member 310 is rotatably coupled at a first pivot joint 315 to a pivot member 320. The pivot member 320 is rotatably coupled at a second pivot joint 325 to a coupling member 330. In some examples, the lens module 305 may rotate along a first axis 335 about the first pivot joint 315 relative to the pivot member 320. The lens module 305 may, for example, rotate along a second axis 340 about the second pivot joint 325 relative to the coupling member 330. In this example, the coupling member 330 may be slidably and releasably assembled with a clip 345 via a coupling receiver 350. In various embodiments, the pivot joint 315 may include, by way of example and not limitation, a screw, a pin, a bolt, or some combination thereof.

In some implementations, the lens module 305 may be rotated around the second pivot joint 325. The second pivot joint 325, which couples the pivot member 320 to the coupling member 330, may be provided with a plurality of pre-determined orientations. For example, the second pivot joint 325 may be configured to urge the pivot member 320 into one of two positions substantially perpendicular to each other.

In various embodiments, the second pivot joint 325 may, by way of example and not limitation, be formed as a ‘knuckle’ joint such that the joint is urged at any point in rotation towards one of at least two predetermined orientations. In some embodiments, the second pivot joint 325 may, for example, be provided with a cam and/or cam-like action. In some variations, the second pivot joint 325 may be provided, for example, with a ratcheting action with a plurality of stop points. Some embodiments may, for example, have a spring-loaded second pivot joint 325. In some embodiments the second pivot joint 325 may be provided with a clamping action. Various embodiments may, for example, be provided with a friction clutch action with respect to the second pivot joint 325.

In various embodiments, the lens module 305 may be advantageously transitioned between a plurality of predetermined orientations which may include at least a viewing mode and a stowage mode.

The pivot member 320 may be rotated about the first pivot joint 315. The pivot joint 315, which couples (as depicted) the pivot member 320 to the lateral attachment member 310, in some implementations may be omitted. For example, the first pivot joint 315 may non-rotatably connect the pivot member 320 to the lateral attachment member 310. In some examples, a fixed first pivot joint 315 may advantageously stabilize the lens module 305 at a desired position.

In various embodiments, when positioning on a mounting surface (such as, for example, a hat brim), the clips 345 may advantageously be oriented in a desired configuration on the surface by rotating the clip 345 and, thus, the coupling receiver 350, the coupling member 330, and/or the pivot member 320, about the pivot joint 315.

The coupling receiver 350 may, by way of example and not limitation, be a substantially hollow cylinder, as depicted. In some implementations, the coupling receiver may be a rectangular sleeve with retaining features. For example, the coupling receiver 350 may include internal or external protrusions, cavities, and/or other retaining features by employing various materials and/or mechanical/chemical configuration. In various embodiments, the coupling receiver 350 may advantageously permit the clip 345 to rotate about a longitudinal axis of the coupling receiver 350 and, thereby, relative to the coupling member 330. For example, when the clip 345 is attached to a curved hat brim, the clips 345 may advantageously be rotated in coupling receivers 350 relative to coupling members 330 such that flats of the clips 345 may advantageously align with and grip the curved hat brim.

In this example, the clip 345 includes a spring plate 355, a leading element 360, and an offset 365. When the clip 345 is slidingly assembled into the coupling receiver 350 with the coupling member 330, the spring plate 355 may pressingly engage the coupling receiver 350 and the coupling member 330. For example, the spring plate 355 may press the coupling member 330 against the coupling receiver 350 such that coupling member 330 is releasably coupled to the clip 345 by the coupling receiver 350 and the spring plate 355. In some examples, the spring plate 355 may be, by way of example and not limitation, a spring, a releasable fastener (e.g., pinned, bolted, screwed, or otherwise releasably fastened), integral to the clip, assembled with the clip, or some combination thereof.

The leading element 360 is depicted in FIG. 3 with a rounded ‘bullnose’ feature. In other examples, the leading element 360 may, by way of example and not limitation, include a chamfered feature. Some embodiments may be provided with a leading element 360 having a radiused feature. In various embodiments the leading element 360 may be provided with an angled feature. The leading element 360 may advantageously provide for registration and engagement of the clip 345 with the edge of a surface. For example, the leading element 360 may advantageously act as a ‘wedge’ to register the clip 345 with a hat brim. The leading element 360 may advantageously permit the clip 345 to be releasably coupled to the hat brim.

In this example, the clip 345 includes a spring element 370 for registering and engaging an attachment surface, such as a hat brim. The spring element 370, in this example, is integral to the clip 345. In various embodiments, at least some portion of the clip 345 may be spring steel or other suitable elastic material for expanding and fitting onto an attachable surface. In various embodiments, the spring element 370 may be, by way of example and not limitation, integrated as depicted. In some embodiments the spring element 370 may include and/or be configured as an integrated region of elastic material. In various embodiments the spring element 370 may be a separate spring component (e.g., extension spring, compression spring, torsion spring) in a clip assembly. In various embodiments, the spring element 370 may advantageously provide a clamping force to releasably couple the clip 345 to a surface such as, by way of example and not limitation, a hat brim, a sun visor, other suitable structure, or some combination thereof.

In some examples, the offset 365 may space the coupling member 330 and, thus, the lens module 305 after assembly, at a predetermined distance from an attachment surface of which the clip 345 is attached. The offset 365 may, by way of example and not limitation, be fixed, or be adjustable (e.g., a bendable offset, a reconfigurable or repositionable offset). In some examples, the offset 365 may be integrated to the clip 345 as depicted, include at least one component assembled to the clip 225, or some combination thereof. In various embodiments, the offset 365 may advantageously position the lens module 305, when attached to a surface via clip 225, in a user's desired line of sight in the viewing mode.

For example, the pivot joint 315 may be configured such that the lens module 305 to be rotated, relative to the coupling member, about a first axis, each coupling module comprising an engagement module configured to releasably engage a brim of a headwear and to independently rotate relative to the lens module.

In various implementations, when the attachable eyewear 300 is attached to a brim of a headwear, a user wearing the headgear may advantageously adjust the position of the lens module 305 relative to the coupling receiver 350, independent of the lens module 305, to a desired position such that, for example, the second axis 340 is substantially orthogonal to a viewing axis of the user. In some examples, the user can then selectively rotate the lens module 305 about the second axis 340. For example, the user may operate the lens module 305 about the second axis 340 to selectively operate the attachable eyewear 300 between a deployed mode and a stowed mode. For example, in the deployed mode, the lens module 305 may intersect the viewing axis of the user. For example, in the stowed mode, the lens module 305 may be substantially removed from the viewing axis of the user.

Although various embodiments have been described with reference to the figures, other embodiments are possible. For example, although various embodiments have been described in reference to clips adapted for mounting on surfaces such as hat brims, other appropriate mounting mechanism and surfaces may be implemented. By way of example and not limitation, mounting mechanisms may include clips, hooks, clamps, magnets, suction cups, inclined plane fasteners (e.g., screws), wedge fasteners (e.g., nails), other appropriate mechanisms, or some combination thereof. By way of example and not limitation, surfaces may include headwear (e.g., hats and helmets), sun visors, workstations (e.g., desks, shelves, and the like), other appropriate surfaces, or some combination thereof. In various embodiments, clips may, for example, be omitted or integrated into various headwear or other mounting surfaces.

In various embodiments, eyeglasses may include, by way of example and not limitation, magnifying glasses (e.g., reading glasses and jeweler's glasses), prescription glasses, or some combination thereof. Glasses may, for example, include safety glasses (e.g., ANSI-compliant impact glasses, laser safety glasses, shooting glasses, chemical safety glasses, oxy-fuel cutting glasses, and welding glasses), visors, face shields, goggles, or some combination thereof. In some embodiments glasses may include virtual reality glasses and/or goggles.

In some implementations, more than one set of lens may be used simultaneously in the attachable eyewear 100. For example, the attachable eyewear 100 may be flipped down in front of a pair of safety glasses. For example, a user may use the attachable eyewear 100 to see detail of an object while still protecting the eyes of the user. In some examples, reading glasses may be attached to a hat such that a user may selectively operate them to read instructions on a user manual without removing the user's safety glasses.

In various implementations, the user may protect the attachable eyewear 100 using the stowage mode in hazardous environment. For example, in a hazardous jobsite, the attachable eyewear 100 may be advantageously protected from wind, scratching from objects, folding debris, and other hazardous collision by being operating in the stowage mode.

In various implementations, the attachable eyewear 100 may be configured to hold more than one set of lenses. For example, the attachable eyewear 100 may include a pair of reading glasses and a pair of distance glasses. For example, a user may selectively operate one of the lens for viewing. In some examples, the user may adjust his/her point of focus by having several pairs of glasses which are selectively operable. In some embodiments, a single attachable eyewear system (e.g., attachable eyewear 100) may be configured to receive multiple lens assemblies (e.g., having multiple coupling modules). In some embodiments, multiple lens assemblies (e.g., attachable eyewear 100) may be deployed on a single hat (e.g., by translation and/or rotation of the coupling modules).

In various embodiments, for example, various components may be omitted, combined, separated, integrated, or some combination thereof. For example, a coupling receiver may be combined or integrated with a clip, a coupling member may be combined and/or integrated with coupling receiver. In some embodiments a coupling member may be combined and/or integrated with a clip. In various embodiments a coupling member may, for example, be integrated with a clip and having no coupling receiver. Such an assembly may be provided, for example, with at least some portion which is at least partially axially rotatable (e.g., a rotatable joint or a torsion spring).

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. An eyewear assembly for attaching to headgear, comprising:
a lens module comprising at least one optical lens element; and,
at least two coupling modules rotatably coupled to a distal end and a proximal end of the lens module, respectively, such that the lens module can be rotated, relative to the coupling modules, about a first axis, each coupling module comprising:
an engagement module configured to releasably engage a brim of a headwear and to independently rotate relative to the lens module; and
a sleeve with retaining features, wherein:
when the coupling modules are operated to rotate into register with the brim and the engagement modules are operated to releasably couple the lens module to the brim such that the first axis is substantially orthogonal to a viewing axis of a user when the headwear is deployed on a head of the user, then the lens module is selectively operable, by rotation of the lens module about the first axis, between at least a deployed mode and a stowed mode,
in the deployed mode, the lens module intersects the viewing axis of the user, and,
in the stowed mode, the lens module is substantially removed from the viewing axis of the user.

2. The eyewear assembly of claim 1, wherein the sleeve further comprises a deformable coupling material configured to releasably engage at least part of the engagement module.

3. The eyewear assembly of claim 1, wherein each engagement module further comprises a spring element configured to apply a clamping force to releasably couple the engagement module to the brim of the headwear.

4. The eyewear assembly of claim 1, wherein each engagement module further comprises an offset element configured such that, when the eyewear assembly is releasably coupled to the headwear, the user may selectively adjust a vertical distance between the lens module and the brim of the headwear.

5. The eyewear assembly of claim 1, further comprising:
a first pivot joint rotatably coupling the lens module to the corresponding coupling module such that the lens module is selectively rotatable about the first axis; and
a pivot member coupled to the first pivot joint, wherein the pivot member slidably engages with the corresponding coupling module.

6. The eyewear assembly of claim 5, wherein:
the first pivot joint is configured to operate in at least two predetermined orientations,
a first of the at least two predetermined orientations corresponds to a position of the lens module in the deployed mode, and
a second of the at least two predetermined orientations corresponds to a position of the lens module in the stowed mode.

7. The eyewear assembly of claim 5, further comprising, for each coupling module: a second pivot joint configured such that the lens module is rotatable relative to the coupling module about a second axis.

8. The eyewear assembly of claim 1, wherein the lens module further comprises at least two optical lens elements; wherein, in the deployed mode, the user may selectively operate at least one of the lens elements for viewing.

9. An eyewear assembly for attaching to headgear, comprising:
a lens module comprising at least one optical lens element; and,
at least two coupling modules rotatably coupled to a distal end and a proximal end of the lens module, respectively, such that the lens module can be rotated, relative to the coupling modules, about a first axis, each coupling module comprising an engagement module configured to releasably engage a brim of a headwear and to independently rotate relative to the lens module, wherein:
when the coupling modules are operated to rotate into register with the brim and the engagement modules are operated to releasably couple the lens module to the brim such that the first axis is substantially orthogonal to a viewing axis of a user when the headwear is deployed on a head of the user, then the lens module is selectively operable, by rotation of the lens module about the first axis, between at least a deployed mode and a stowed mode,
in the deployed mode, the lens module intersects the viewing axis of the user, and,
in the stowed mode, the lens module is substantially removed from the viewing axis of the user.

10. The eyewear assembly of claim 9, wherein each of the coupling modules further comprises a sleeve with retaining features.

11. The eyewear assembly of claim 10, wherein the sleeve further comprises a deformable coupling material configured to engage at least part of the engagement module.

12. The eyewear assembly of claim 9, wherein the engagement modules each further comprise a spring element configured to apply a clamping force to releasably couple the corresponding engagement module to the brim of the headwear.

13. The eyewear assembly of claim 9, wherein each engagement module further comprises an offset element configured such that, when the eyewear assembly is releasably coupled to the headwear, the user may selectively adjust a vertical distance between the lens module and the brim of the headwear.

14. The eyewear assembly of claim 9, further comprising, for each coupling module:
a first pivot joint rotatably coupling the lens module to the corresponding coupling module such that the lens module is selectively rotatable about the first axis; and
a pivot member coupled to the first pivot joint, wherein the pivot member slidably engages with the corresponding coupling module.

15. The eyewear assembly of claim 14, wherein:
the first pivot joint is configured to operate in at least two predetermined orientations,
a first of the predetermined orientations corresponds to a position of the lens module in the deployed mode, and,
a second of the predetermined orientations corresponds to a position of the lens module in the stowed mode.

16. The eyewear assembly of claim 14, further comprising, for each coupling module: a second pivot joint configured such that the lens module is rotatable relative to the coupling module about a second axis.

17. The eyewear assembly of claim 9, wherein:
the lens module further comprises at least two optical lens elements, and,
in the deployed mode, the user may selectively operate at least one of the lens elements for viewing.

18. An eyewear assembly for attaching to a brim of a headwear, comprising:
a lens module comprising at least one optical lens element; and,
at least two coupling modules rotatably coupled to a distal end and a proximal end of the lens module, respectively, such that the lens module can be rotated, relative to the coupling modules, about a first axis, each coupling module comprising means for releasably engaging a brim of a headwear and to independently rotate relative to the lens module, wherein:
when the coupling modules are operated to rotate into register with the brim and the means for releasably engaging the brim are operated to releasably couple the lens module to the brim such that the first axis is substantially orthogonal to a viewing axis of a user when the headwear is deployed on a head of the user, then the lens module is selectively operable, by rotation of the lens module about the first axis, between at least a deployed mode and a stowed mode,
in the deployed mode, the lens module intersects the viewing axis of the user, and,
in the stowed mode, the lens module is substantially removed from the viewing axis of the user.

19. The eyewear assembly of claim 18, wherein the coupling module comprises a sleeve with retaining features.

20. The eyewear assembly of claim 18, wherein the lens module further comprises at least two optical lens elements; wherein, in the deployed mode, the user may selectively operate at least one of the lens elements between the stowed mode and the deployed mode.
